(19) United States
(12) Patent Application Publication
(10) Pub. No.: US 2017/0247193 A1
(43) Pub. Date: Aug. 31, 2017

(54) BELT CONVEYOR WITH LONG-TOOTH SPROCKETS OR DRUMS

(71) Applicant: Laitram, L.L.C., Harahan, LA (US)

(72) Inventor: Achraf Elhassouni, Flower Mound, TX (US)

(21) Appl. No.: 15/518,441

(22) PCT Filed: Sep. 14, 2015
(86) PCT No.: PCT/US2015/050005

§ 371 Date: Apr. 11, 2017

Related U.S. Application Data
(60) Provisional application No. 62/072,151, filed on Oct. 29, 2014.

(51) Int. Cl. B65G 23/06; F16H 55/30

(52) U.S. Cl. CPC B65G 23/06; F16H 55/30

(57) ABSTRACT

A belt conveyor comprising a foraminous conveyor belt wrapped around sprockets and a method for helping release products adhering to the conveyor belt. The belt has openings through its thickness and across its length and width that admit sprocket teeth. The whole depth of the teeth is greater than the thickness of the belt so that the teeth protrude past the conveying side of the belt and help release the products off the end of the belt by pushing the products away from, and breaking their adherence to, the conveying side.

### BACKGROUND

The invention relates generally to power-driven conveyors and more particularly to belt conveyors with sprocket-driven modular conveyor belts.

Foraminous modular conveyor belts are often used to transport food items. Parts of the food items can break off and become lodged in the sides of the openings in the foraminous belts. Cleaning the belts to dislodge and remove such debris is time-consuming. Another problem arises in the conveying of food products coated with fats, grease, or viscous liquids. As one example, bacon slabs or slices tend to stick to the belt's conveying surface at the end of the belt run. If they cling to the belt as it rounds the end sprockets, they will not proceed to the downstream conveyor.

### SUMMARY

One version of a conveyor embodying features of the invention comprises a conveyor belt having openings spaced apart across its width and extending through its thickness from an inner side to an outer conveying side. A reversing element has teeth that extend radially outward to top ends. The teeth are received in the openings in the rows from the inner side. The top ends of the teeth extend past the outer conveying surface of the conveyor belt.

In another aspect of the invention, a method for releasing products and cleaning debris from a conveyor belt, comprises: (a) conveying products on the conveying side of a conveyor belt having openings through its thickness; (b) wrapping the conveyor belt around the periphery of a rotating reversing element to reverse the direction of the conveyor belt at an end of the conveyor; and (c) extending teeth that protrude radially outward from the periphery of the reversing element through the openings and past the conveying side of the conveyor belt to push debris out of the openings and break the adherence of the products to the conveying side for transfer off the end of the conveyor.

### BRIEF DESCRIPTION OF THE DRAWINGS

FIG. 1 is an axonometric view of a sprocket usable in a conveyor embodying features of the invention;

FIG. 2 is a side elevation view of a belt conveyor including a sprocket as in FIG. 1 driving a modular conveyor belt; and

FIG. 3 is a flattened top view of the sprocket and conveyor belt of FIG. 2.

### DETAILED DESCRIPTION

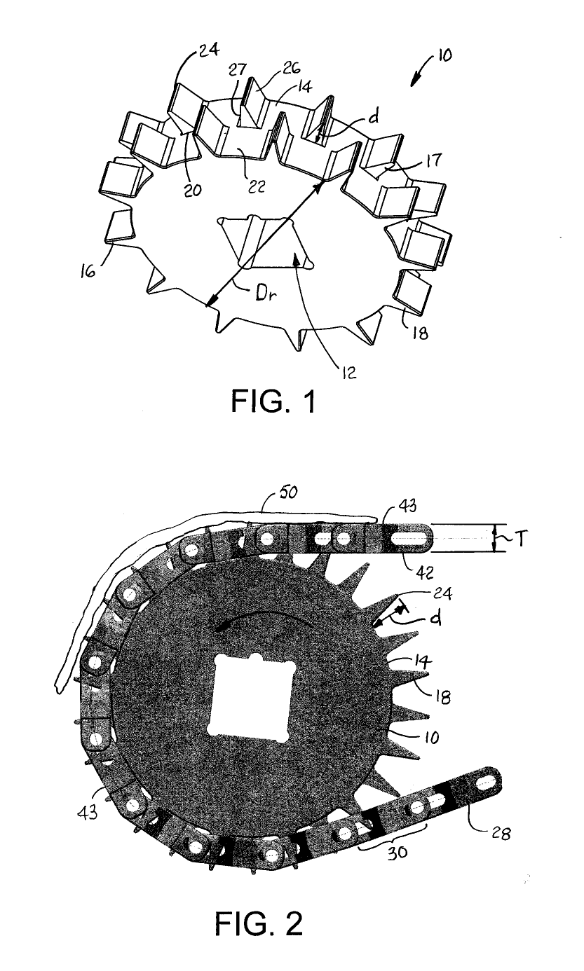

A sprocket usable in a belt conveyor system embodying features of the invention is shown in FIG. 1. The sprocket 10 has a central axial bore 12 and an outer periphery 14. Two sets 16, 17 of teeth 18 extend radially outward from the periphery 14 for engaging a conveyor belt and reversing its direction. In this example, the teeth of each set are spaced apart circumferentially around the periphery of the sprocket. The teeth in the first set 16 are circumferentially and axially offset from the teeth in the second set 17. As another example, a sprocket with only a single circumferential row of teeth could be used. Or a drum with a toothed outer surface can be used as well as sprockets. Thus, one or more sprockets or a wide drum can be used as a reversing element for a conveyor belt.

Each tooth 18 extends radially outward from a root end 20 at a bottom land 22 between consecutive teeth to a distal top end 24. The bottom land 22 and the roots of the teeth define the sprocket's root diameter Dr. The distance d from the root diameter to the top end of the teeth is defined as the tooth's whole depth. In this example, all the teeth are thin isosceles triangles when viewed from the side. One of ordinary skill in the art will recognize that other tooth shapes are possible to meet other geometric or technical requirements. Each tooth 18 also has leading and trailing drive faces 26, 27. The bore 12 receives a drive or idle shaft (not shown) that can rotate in one or both directions. If multiple sprockets are used as the reversing element, they would be axially aligned on the shaft.

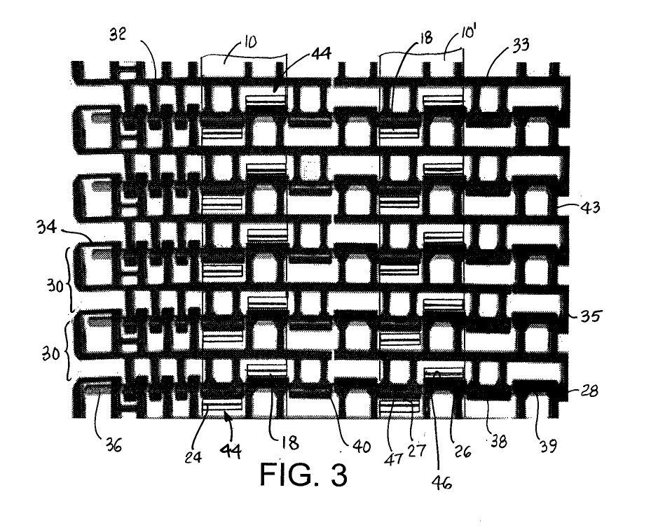

A modular conveyor belt 28 is shown wrapped around a portion of the periphery 14 of the sprocket 10 in FIGS. 2 and 3. The modular belt is constructed of a series of rows 30 of one or more belt modules 32, 33, 34, 35. The rows are hingedly linked together by hinge rods 36 in interleaved hinge eyes 38, 39 forming hinge joints 40 between adjacent rows.

Each belt row extends in thickness T from an inner driven side 42 to an outer conveying side 43. Openings 44 in the belt extend through the thickness T from the inner side 42 to the outer side 43. Each belt row 30 has openings 44 spaced apart across its width. The sprocket teeth 18 are received in some of the openings. FIG. 3 shows two axially spaced sprockets 10, 10′ engaged with the belt 28. (The sprockets 10, 10′ and the belt are shown flattened in FIG. 3 for illustrative purposes.) The drive faces 26, 27 of the sprockets 10, 10′ push against (in the case of drive sprockets) or are pushed against by (in the case of idle sprockets) drive surfaces 46, 47 bounding the openings 44 in the modules. As best shown in FIG. 2, the whole depth d of the teeth is greater than the thickness T of the belt rows. Thus, the top ends 24 of the teeth 18 extend past the outer conveying side 43 of the belt when the belt is wrapped around the sprockets 10 with its inner side resting on the bottom lands 22. At the end of the belt's carryway run, as in FIG. 2, the long teeth 18 protruding through the belt 28 where it wraps around the sprocket 10 push a conveyed product 50 away from the outer conveying side 43. In this way the long teeth 18 break the product's adherence to the conveying side 43 and help release the product off the end of the belt 28. The teeth can also help dislodge debris caught in the openings 44.

What is claimed is:

1. A conveyor comprising:
a conveyor belt having openings spaced apart across its width and extending through the thickness of the conveyor belt from an inner side to an outer conveying side;
a reversing element having teeth extending radially outward to top ends and received in the openings in the rows from the inner side, wherein the top ends of the teeth extend past the outer conveying surface of the conveyor belt.

2. A conveyor as in claim 1 wherein the depth of the teeth is greater than the thickness of the conveyor belt.

3. A conveyor as in claim 1 wherein the reversing element has a periphery and the teeth extend radially outward of the periphery from root ends to the distal top ends for engaging the conveyor belt from the driven side, wherein the distance from the root end to the top end defines the whole depth of the teeth.

4. A conveyor as in claim 3 wherein the conveyor belt is a modular conveyor belt constructed of a series of rows of one or more belt modules hingedly linked together, wherein each of the rows extends in thickness from an outer conveying side to an inner driven side, wherein the whole depth of the teeth is greater than the thickness of the rows of the modular conveyor belt so that as the modular conveyor belt wraps around a portion of the periphery of the reversing element some of the teeth extend through the openings with the top ends of the teeth protruding past the outer conveying side of the rows seated on the periphery of the reversing element.

5. A conveyor belt as in claim 1 wherein the reversing element has two sets of circumferentially spaced teeth, each set axially and circumferentially offset from the other set.

6. A method for releasing products and cleaning debris from a conveyor belt, comprising:
conveying products on the conveying side of a conveyor belt having openings through its thickness;
wrapping the conveyor belt around the periphery of a rotating reversing element to reverse the direction of the conveyor belt at an end of the conveyor;
extending teeth that protrude radially outward from the periphery of the reversing element through the openings and past the conveying side of the conveyor belt to push debris out of the openings and break the adherence of the products to the conveying side for transfer off the end of the conveyor.

7. The method of claim 6 further comprising driving the conveyor belt with the drive teeth on the rotating reversing element.
